(19) United States
(12) Patent Application Publication
(10) Pub. No.: US 2018/0150195 A1
(43) Pub. Date: May 31, 2018

(54) SOCIAL NETWORKING SYSTEM AND METHOD FOR ALLOWING USERS TO VIEW, MANAGE AND RESPOND TO A PLURALITY OF NEWS EVENTS

(71) Applicant: JOHNNY LUGO, CAROLINA, PR (US)

(72) Inventor: JOHNNY LUGO, CAROLINA, PR (US)

(21) Appl. No.: 15/361,159

(22) Filed: Nov. 25, 2016

(51) Int. Cl. G06F 3/0484; H04L 29/08; G06F 3/16; G06F 3/0481; G06F 1/16

(52) U.S. Cl. CPC G06F 3/0484; H04L 67/306; G06F 1/163; G06F 3/04817; G06F 3/167

(57) ABSTRACT

A computer implemented social networking system and method to enable a user to view and comment on a variety of contents is disclosed. The system includes a social networking application to present the contents including a variety of news events to the users and to receive comments on the news events from the users. The social networking application allow the users to view, interact and react to the news events using short audio comments. The news events are presented through a graphical user interface of the social networking application and are made available to the users for a preset period of time. The social networking application allows the users to listen to the plurality of short audio comments, which are posted in response to the news events, from a number of other registered users and respond to the received short audio comments using their own short audio comments.

### BACKGROUND OF THE EMBODIMENT

### Technical Field of the Embodiment

The present embodiment relates to system and method for implementing a social media network based on latest news events. More specifically, the present embodiment relates to a system and method including a social networking application to allow a number of users to view, interact and react to latest news events.

### Description of the Related Art

The Internet has changed the way that we view news. Instead of having a TV producer or a newspaper editor determine the most important stuff for us, we are now free to explore the Web to find the news that matters most to us. There are a number of websites that deliver the news and it is difficult for user to keep track of all of those websites. Many social networking applications and websites exist today where users can view a verity of contents posted by other users, interact with a number of other users, and can comment on the contents posted by other users through an electronic communication device such as a smartphone. However the users are fed with the variety of contents, which may include unwanted and old contents by the users, received through a user interface of the social networking application. Social networking platforms, such as Facebook, allow users to post a verity of contents including old and latest news events through the user interface. Other users can view the contents posted by the first user and can comment, like or share the contents. However these options do not allow the users to receive latest news events, listen to reaction of other users on the latest news events and react to those latest news events conveniently.

There are a variety of news applications available for smartphones and other smart devices that allow the users to choose their own news sources and create their own news feed. When the user opens the app, they receive articles from only those selected sources. This is great for anyone who wants to have control over where they get their news, and the applications also allows the users to create categories for the news. Some news applications also come with a web interface so that the users can read the news on other devices. Some other existing applications present worldwide news that covers a wide variety of topics to the users through a user interface of the application. Using similar applications users can find the latest news on current events, sports, technology, politics, etc. The application also allows the users to save news articles for later reading, engage with video and audio content, read and share comments, etc. However all the existing news related applications do not allow people to interact with other people and exchange opinions on the news in an easy and convenient way.

There are certain prior arts, which are herein incorporated by reference for their supportive teachings, in which they are as follows:

US 20140143241 A1 titled “Internet news platform and related social network” filed by Daniel Dee Barello talks about a method, related system, and related non-transitory, computer-readable storage medium that implements a social network for aggregating Internet news, and, more specifically, receiving and presenting news content to a user of the social network. The system includes a computer processor and a routing engine executing on the processor and configured to receive a first content at a server, wherein said first content is ranked by at least one user, receive a second content at a server, link the second content to the first content, receive a request for content, filter the request for content using at least one geographic location as a filtering parameter and display the results of the request for content on a geographic map, wherein the prominence of each content displayed is determined according to at least the content's ranking. However the above applications do not allow people to interact with other people and exchange opinions on the news in an easy and convenient way.

US 20130018960 A1 titled “Group Interaction around Common Online Content” filed by Surfari Inc. discloses an on-line system that allows a group of people to interact around common content. The system includes a computer network; a server system coupled to the computer network; and multiple user devices, each of which is coupled to the computer network and each of which is associated with a respective member of the group, in which the server system stores identification information for each member of the group, and in which, in response to receiving a lead to content initiated by a member of the group, the server system is configured to send a reference to the content to the respective user devices of the other members of the group. In response to receiving the reference to the content, at least some of the user devices automatically access and load the content via the network. However the above applications do not allow people to interact with other people and exchange opinions on the news in an easy and convenient way.

Another application US 20150254261 A1 titled “News Application” provides a news application where a user can log into an account on a server and submit an article. An article can include text, images, videos, links and other information. The article also has metadata associated with the article. After a user submits an article to the server an analysis of the article is completed. The article is either published or referred to an editor for further review. Readers of the article can comment or vote on the article, which affects how likely the article is found in a subsequent search by another reader. However the above applications do not allow people to interact with other people and exchange opinions on the news in an easy and convenient way.

Hence, it can be seen that there is a need for a system and method for presenting latest and tailored news contents to each user. The needed system and method would allow the users to interact with other users and exchange opinions on the latest news in an easy and convenient way. Moreover the needed system and method would allow the users to comment on any latest news event across the world anonymously.

### SUMMARY OF THE INVENTION

The present invention is a computer implemented social networking system and method to enable a number of users to provide comments in response to a variety of contents presented to the users. The system includes an electronic communication device capable of running a social networking application for enabling the users to interact with the contents and to provide the comments in response to the contents presented through a graphical user interface of the social networking application. The system further includes a server in communication with the electronic communication device to manage the contents presented to the users, comments received from the users and other information related to the users including content preferences by the user. The electronic communication devices communicate with the server over a communication channel. The social networking application launched from the electronic communication device allows the users to view and interact with the variety of contents and to provide the number of comments in response to the contents in form of a short audio message or comment. Each of the news events presented through the graphical user interface of the social networking application are available only for a preset period of time. The social networking application allows the users to listen to the plurality of short audio comments related to the news events from a number of other registered users and respond to those short audio comments with their own audio comments. The present system allow the users to interact with other registered users and exchange opinions or response on the contents such as the latest news events presented through the graphical user interface of the social networking application and allow the user's voice to be heard in an anonymous way.

The present method includes the steps of launching the social networking application from the electronic communication device and prompting the users to register into the social networking application by providing required information through the graphical user interface (GUI) of the social networking application. After registration, the users can login to view the contents presented through the GUI of the social networking application. The contents include a variety of news events on topics selected by the user. The news events are presented to the users through the GUI of the social networking application for a preset period of time. Now the users can comment on the news events by posting one or more short audio comment as response. The social networking application also enables the users to listen to the short audio comments from a number of other registered users and exchange their opinion in form of the short audio comments. Thus the present social networking application allows the users to view the news events, react to the news events through the short audio comments and exchange a variety of opinions on the news events with the other registered users in form of the short audio comments. In addition, the social networking application converts the user profile image of the user into a desired avatar image including a cartoon image to protect anonymity of the user, while posting the short audio comments.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a computer implemented social networking system to enable the users or the public to provide a desired comment in response to a variety of contents presented to the users through the online platform, according to a preferred embodiment of the present disclosure;

FIG. 2 is a block diagram showing the different components and modules of the electronic communication device running the social networking application, according to a preferred embodiment of the present disclosure;

FIG. 3 is a block diagram showing the different components and modules of the server in communication with the electronic communication device running the social networking application, according to a preferred embodiment of the present disclosure;

FIG. 4A to 4D shows the graphical user interface of the social networking application running on the electronic communication device such as a Smartphone, according to a preferred embodiment of the present disclosure; and

FIG. 5 is a flow chart showing the steps of the present method for utilizing the social networking application to provide a variety of contents to a number of users and to receive a variety of short audio comments from the users in response to the contents.

### DETAILED DESCRIPTION OF THE ILLUSTRATED EMBODIMENTS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

The present disclosure relates to a system and method for allowing users to interact with other users around the world and exchange opinions on a variety of latest events around the world through an online platform. The present system and method assists the users to express their opinions on the latest events around the world, which are published through the online platform, in form of short-recorded audio comments. Further the present system and method allows the users to listen to the opinions of other people on the latest events published through the online platform.

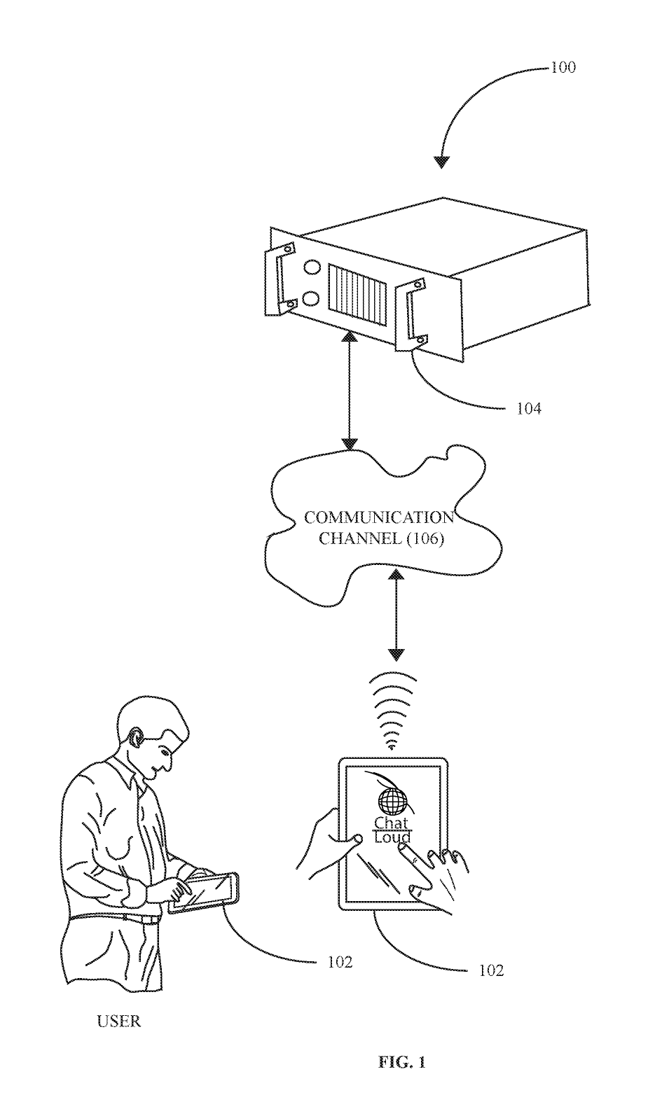

Referring now to FIG. 1, there is illustrated a computer implemented social networking system 100 to enable the users or the public to provide a desired comment in response to a variety of contents presented to the users through the online platform. The computer implemented social networking system 100 includes one or more electronic communication devices 102 capable of running a social networking application configured to present the variety of contents to the users through a graphical user interface (GUI) of the social networking application. The social networking application allows the users to view the contents presented through the graphical user interface and respond or react to the contents by providing one or more comments through the social networking application. The electronic communication device 102 includes smart devices such as, but not limited to, a smartphone, tablet, computer, smart wearable devices, and other smart devices capable of displaying the graphical user interface of the social networking application. The computer implemented social networking system 100 further includes a server 104 in communication with the electronic communication device 102 to manage the plurality of contents presented to the users through the social networking application running on the electronic communication device 102. The server 104 is in communication with the electronic communication device 102 over a communication channel 106 such as Internet to manage the contents presented to the users, the comments or responses to the comments received from the users and a variety of information related to the users. A user can launch the social networking application from the electronic communication device 102 to allow the users to interact with the contents and to provide the comments in response to the contents. In a preferred embodiment of the present disclosure, the users are allowed to respond to the contents displayed through the graphical user interface of the social networking application in form of one or more short audio comment. Further the social networking application includes a portable smart device application such as, but not limited to, an iOS application or Android application and a social networking web application having the graphical user interface (GUI) to provide the contents to the users. In addition, according to the preferred embodiment of the present disclosure, the contents presented to the users through the graphical user interface of the social networking application includes a variety of news events including local and global news events.

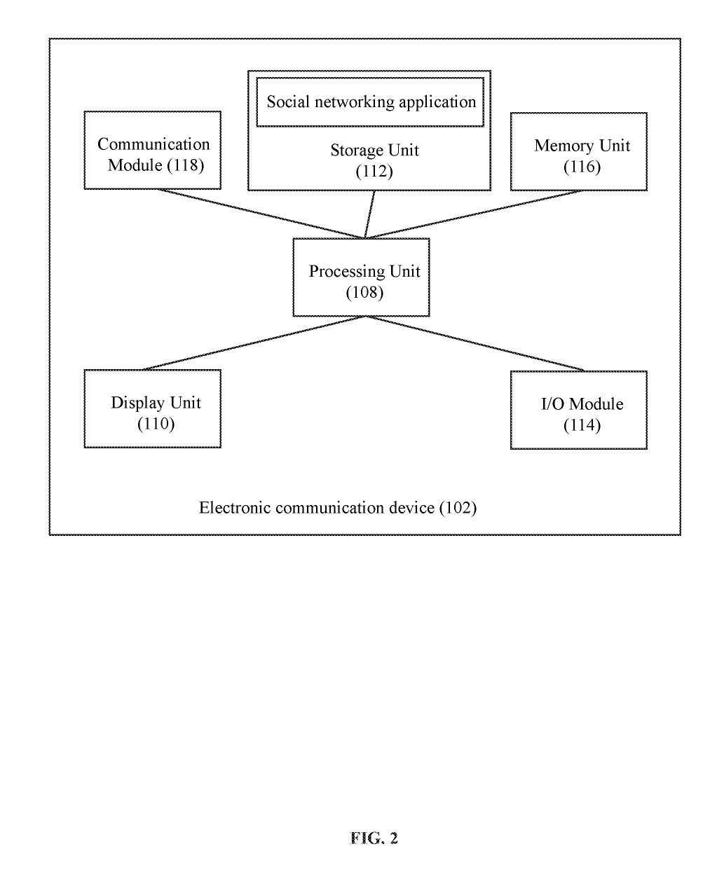

Referring now to FIG. 2, there is a block diagram showing the different components and modules of the electronic communication device 102 running the social networking application, according to a preferred embodiment of the present invention. The electronic communication device 102 can be smart devices such as, but not limited to, a smartphone, tablet, computer, smart wearable devices, and other smart devices connected to the Internet and capable of displaying the graphical user interface of the social networking application. The electronic communication device 102 includes a processing unit 108 to process a number of instructions of the social networking application, a display unit 110 for displaying the graphical user interface of the social networking application, a storage unit 112 for storing a variety of data including data from the social networking application, an input/output module 114 for allowing the user to interact with the graphical user interface of the social networking application, a memory unit 116 for temporarily storing the data while performing a number of operations by the processor based on the instructions of the social networking application and a communication module 118 to enable communication between the electronic communication device 102 and the server 104 via the communication channel 106. The users are allowed to interact with the contents of the social networking application through the graphical user interface using the input/output module 114. The users are allowed to interact with the contents presented on the graphical user interface of the social networking application using a keyboard, pointing device such as a mouse, at least one gesture or touch, voice activation, or any other interacting means. Further the input/output module 114 allows the users to respond or react to the contents presented through the graphical user interface of the social networking application using voice i.e. as audio response or audio comments. Further the input/output module 114 allows the users to listen to the reactions or responses from other users on the contents presented through the graphical user interface of the social networking application. This method allow the users to interact with other people or other users and exchange opinions or response on the contents such as the latest news events presented through the graphical user interface of the social networking application and allow the user's voice to be heard in an anonymous way.

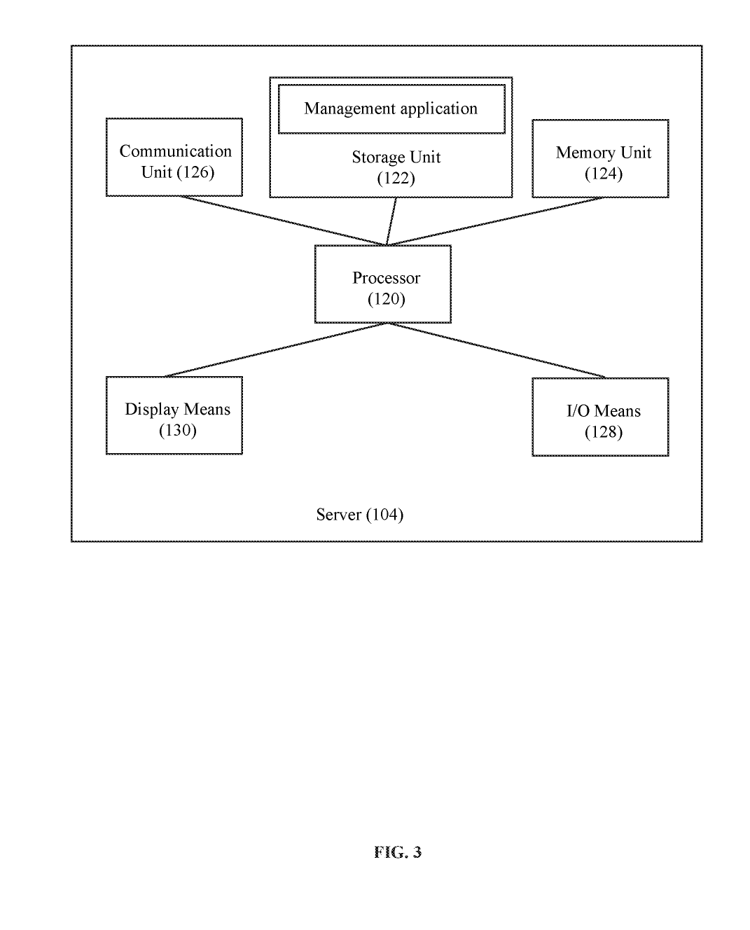

Referring now to FIG. 3, there is a block diagram showing the different components and modules of the server 104 in communication with the electronic communication device 102 running the social networking application, according to a preferred embodiment of the present invention. The server 104 includes similar components as any normal server or a computer, which includes a processor 120, a storage unit 122, a memory unit 124, a communication unit 126, an I/O means 128 and a display means 130. The server 104 is in communication with the electronic communication devices 102 in real-time over the Internet enabled by the communication unit 126. The server 104 is installed with a management application configured to manage the operations of the social networking application running on the electronic communication devices 102. The management application is stored in the storage unit 122 and the processor 120, when required, executes the instructions of the management application. The memory unit 124 stores the data associated with the management application when the processor 120 executes the instructions of the management application. The management application includes a user management module that handles all the information related to the user registration and all other user related activities done through the social networking application running on the electronic communication device 102. The management application running on the server 104 further includes a content management module that selects the contents to be presented through the graphical user interface of the social networking application running on the electronic communication device 102. The content management module manages the contents and the comments on each of the contents by the users provided through the social networking application running on the electronic communication device 102. Further the content management module only displays a particular content for a preset period of time such as for a day or 24 hours. The contents are automatically removed from the user interface of the social networking application running on the electronic communication device 102 after expiration of the preset time period and latest contents across the world and related to a variety of topics are presented through the social networking application running on the electronic communication device 102. A response management module of the management application running on the server 104 manages the comments or responses on the contents by the users. In a preferred embodiment, the comments provided by the users include short audio comments, which are transferred to the server 104 through the response management module. Further the response management module allows the users to listen to comments or responses from other users and allows interacting with other users through the social networking application through short audio comments or audio responses. In a preferred embodiment all the information stored in the server 104 are encrypted to ensure the security of information including the personal information of the users.

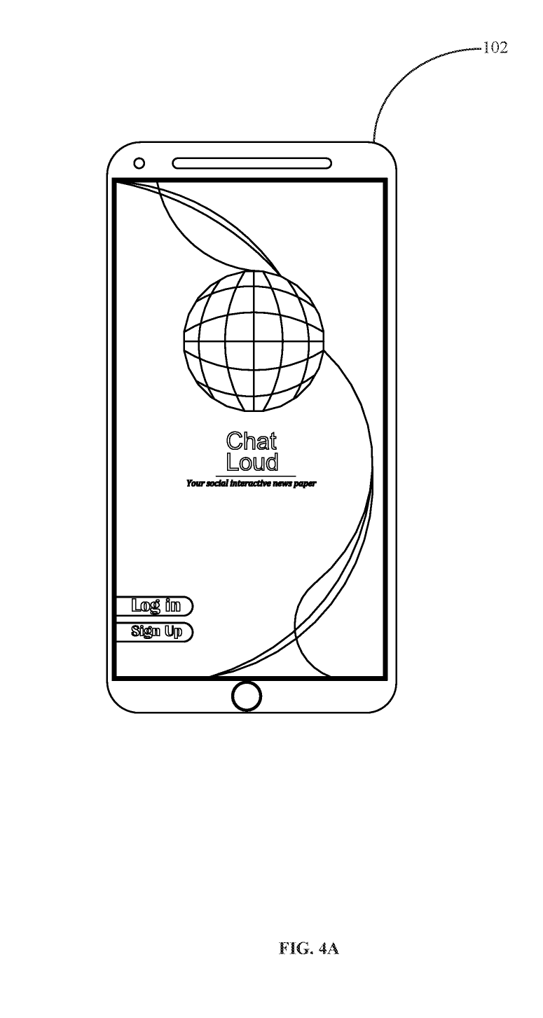

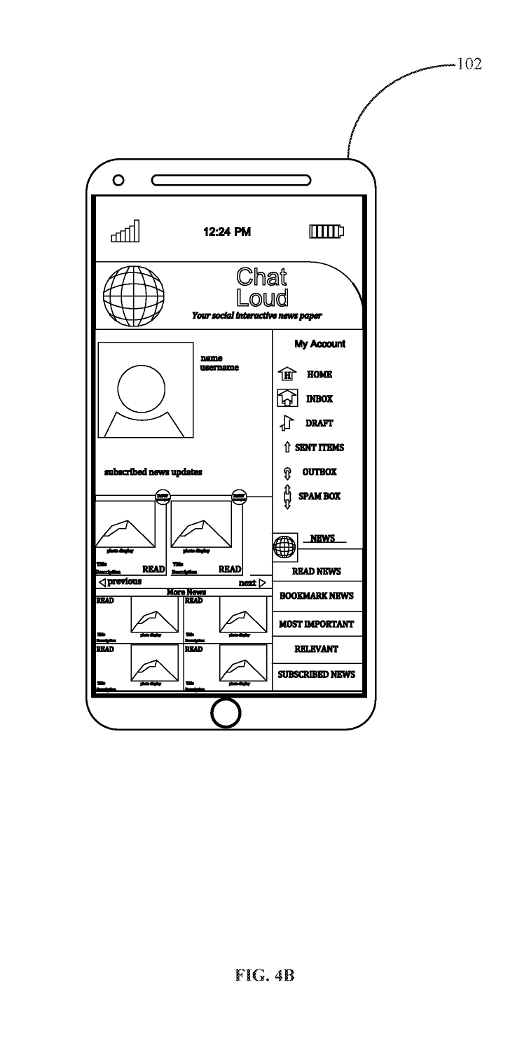

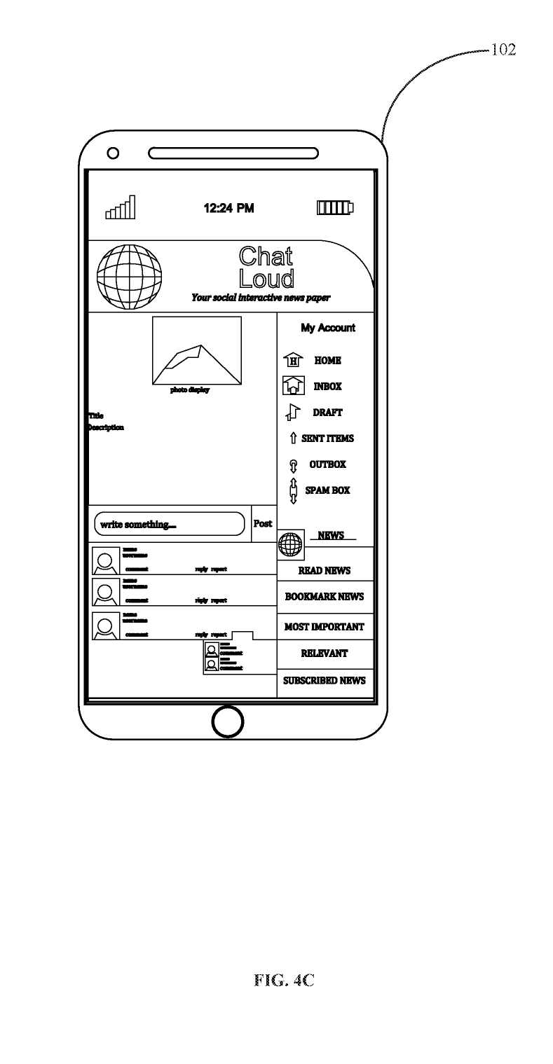

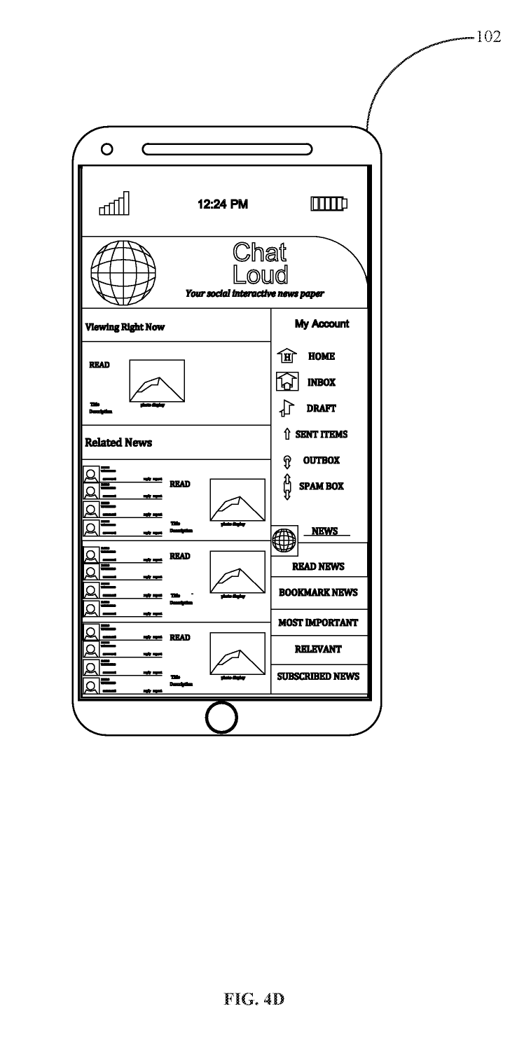

Referring now to FIG. 4A to 4D, there is shown a graphical user interface of the social networking application running on the electronic communication device 102 such as a Smartphone. In a preferred embodiment, the social networking application is a smartphone application configured run on a smartphone such as iOS and Android devices. However the social networking application is available in different versions configured run on other smart devices including smart wearable devices such as smart watch. In some embodiment, the social networking application is a web application that can be launched from a computer or a tablet through the browsers such as Chrome, Mozilla, Safari etc. The users can download the social networking application from online smartphone application stores such as App store, Android store, etc. After downloading and installing the social networking application on the electronic communication device 102, the user can launch the application to visualize the graphical user interface as shown in FIG. 4A. The users are now prompted to register into the smart networking application through the graphical user interface. The users are requested to provide a variety of information including personal information of the user. Further the users can also provide information related to area of interest to enable the management application running on the server 104 to push contents, such as, new events, which are specific to the area of interest, location, etc. through the user interface of the smart networking application. After successful registration the users can login to the smart networking application using unique user credentials provided to the each user. In some instance, the smart networking application allows the users to login using existing accounts in email applications such as Gmail, social networking application such as Facebook etc. In this case the smart networking application automatically collects the personal details of the user and interests and browsing history of the users to identify the area(s) of interest of the user. All the information collected from the users are securely stored in the server 104 and the management application running on the server 104 provides contents such as latest news events, depending on the area of interest and location of interest of the users, through the graphical user interface of the smart networking application.

Referring now to FIG. 4B, there is shown the graphical user interface of the smart networking application showing the contents presented to the user. The social networking application including the smart device application, such as Smartphone App and a social networking web application having a graphical user interface (GUI) similar to the one shown in FIG. 4B to present the users with the plurality of contents including the plurality of news events. Each of the news events is presented through the GUI of the social networking application for a preset period of time. In a preferred embodiment, each of the news events is presented through the GUI for a period of 24 hours. After logging into the smart networking application, the users are prompted to select a profile picture. The smart networking application can access the camera of the electronic communication device 102 such as the smartphone to capture an image of the user and can be uploaded through the application to be used as the profile picture of the user. The social networking application also allows the users to upload a picture stored in the electronic communication device 102. The social networking application includes a security feature that prevents the direct sharing of the profile picture or the facial image of the user. When a user uploads the real picture of the user, the social networking application processes the image and converts the image into a cartoon and uploads it in place of the profile picture of the user. The users can also upload a logo or any other image to describe himself/herself when he/she posts the audio comments on the news events. When a user posts the short audio comment in response to a news event, the short audio comment is publicly posted in response to the news event and all the other users subscribed to the particular news event would be able to listen to the short audio comment. The short audio comments from a user are posted on the graphical user interface of the social networking application along with the username of the user and the profile picture of the user. Since the social networking application converts the profile picture of the user into a cartoon image or an avatar or cartoon representing the profile picture, the users of the present social networking application can post the short audio comments, which is of short duration such as for 30 seconds or more, anonymously without revealing the actual identity such as picture or name of the user. According to the first amendment of the United States constitution, the present method of allowing the users to post the short audio comments on the latest news events allow the freedom of speech of the citizens to reach the next level.

Further the graphical user interface of the present social networking application allows the users to view and make changes to the personal profile information of the user including the profile picture of the user. Further the users can view the past comments on past news events by them and the users can also store the short audio responses or short audio comments as drafts for future postings on the same day. The users can also receive notifications on comments by other users on the news events already commented by the user. These notifications and notifications for other news event topics selected by the user are sent to the inbox as shown in FIG. 4B. The users can view the real time news events that come under the subscribed news topics by the users. The users can scroll through the graphical user interface of the social networking application to view the news events and the comments posted by other users. The user can then select and listen to any comment, i.e. the short audio comment, from the other users and can select to respond or reply to those comments by the other users. The user can then activate the reply button on the graphical user interface of the social networking application to enable the microphone of the electronic communication device 102 and can record the short audio comment, typically of duration of 30 seconds, and can post as the reply. In some instances, the graphical user interface of the social networking application includes like or dislike button to allow the users to agree or disagree to the comments from other users on one or more news events. Further the graphical user interface of the social networking application allows the users to bookmark a particular news event or a comment on any particular news event. Moreover the users can change his/her preference of news types anytime through the user interface of the application.

Referring now to FIG. 4C, it shows the graphical user interface of the smart networking application showing the news creating section for allowing the users to post one or more news events, according to an embodiment of the present disclosure. The user can select a particular news event and add the news event on the smart networking application. The user can upload a picture related to the particular news event and can add a title and describe about the news event, as shown in FIG. 4C. The users can also record and post a short audio comment on the posted news event through the graphical user interface of the smart networking application. In some instances, the smart networking application allows the users to post short text messages in addition to the short audio comment in response to a news event. Also the users can listen to the plurality of short audio comments related to the plurality of news events from a number of other registered users. FIG. 4D shows the graphical user interface of the smart networking application showing the news events fed to the user. The server 104 manages the contents or the news events presented through the social networking application running on the electronic communication device, based on the preference by the user. The server 104 periodically updates the plurality of news events presented through the GUI of the social networking application after the preset period of time, such as after 24 hrs. The users can also view interested or subscribed latest news events and can listen to the comments on those news events by other users. The smart networking application also allows the users to prevent unwanted comments or posts from unauthorized users or users with malicious intent.

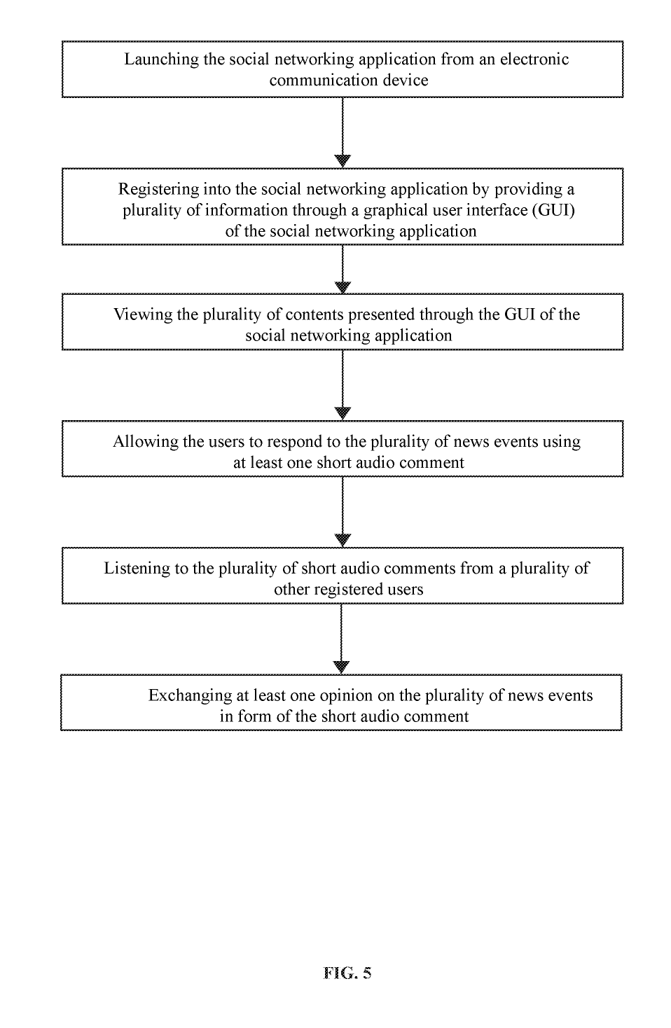

Referring now to FIG. 5, there is a flow chart showing the steps of the present method for utilizing the social networking application to provide a variety of contents, such as news events, to a number of users and to receive a variety of short audio comments from the users in response to the contents. The method includes the steps of launching the social networking application from the electronic communication device 102 and prompting the users to register into the social networking application by providing required information through the graphical user interface (GUI) of the social networking application. After registration, the users can login to view the contents presented through the GUI of the social networking application. The contents include a variety of news events on topics selected by the user. The news events are presented to the users through the GUI of the social networking application for a preset period of time such as for 24 hours. Now the users can comment on the news events by posting one or more short audio comment as response. The social networking application also enables the users to listen to the short audio comments from a number of other registered users and exchange their opinion in form of the short audio comments. Thus the present social networking application allows the users to view the news events, react to the news events through the short audio comments and exchange a variety of opinions on the news events with the other registered users in form of the short audio comments. The social networking application converts the user profile image of the user into a desired avatar image including a cartoon image to protect anonymity of the user, while posting the short audio comments.

According to an embodiment, the present smart networking application allows the users to respond to a particular news event presented to the user using short audio messages of maximum duration of 30 seconds, where the particular news are posted only for a total period of 24 hours. The management application running on the server 104 automatically updates the news events after the preset time. The present smart networking application allows the users to either say his/her opinions or hear the opinions of other people on a variety of news topics or news events. The smart networking application further includes multiple languages to allow regional usage of the application and to allow interaction of the people on a variety of news topics. The smart networking application allows the users to interact with other people, exchange opinions and allow the user's voice to be heard in an anonymous way through the application.

The foregoing description of the preferred embodiment of the present invention has been presented for the purpose of illustration and description. It is not intended to be exhaustive or to limit the invention to the precise form disclosed. Many modifications and variations are possible in light of the above teachings. For example, different user interface designs can be achieved for the smart networking application. Further the smart networking application can be configured to allow the users to post latest news events with relevant information such as picture or video. Moreover the smart networking application can be configured to allow the users to engage in a live debate on one or more news events presented through the graphical user interface of the smart networking application. It is intended that the scope of the present invention not be limited by this detailed description, but by the claims and the equivalents to the claims appended hereto.

I claim as follows:

1. A computer implemented social networking system to enable a plurality of users to provide a plurality of comments in response to a plurality of contents presented to the users, the system comprising:
at least one electronic communication device capable of running a social networking application for enabling the plurality of users to interact with the plurality of contents and to provide the plurality of comments in response to the plurality of contents;
at least one server in communication with the electronic communication device to manage the plurality of contents presented to the users, the plurality of comments received from the users and a plurality of information related to the plurality of users; and
a communication channel for enabling communication between the electronic communication devices and the server;
characterized in that the social networking application launched from the electronic communication device allows the users to view and interact with the plurality of contents and to provide the plurality of comments in response to the plurality of contents in form of at least one short audio comment.

2. The system of claim 1, wherein the social networking application includes a portable smart device application and a social networking web application having a graphical user interface (GUI) to present the users with the plurality of contents including a plurality of news events.

3. The system of claim 2, wherein each of the news events are presented through the GUI of the social networking application for a preset period of time.

4. The system of claim 1, wherein the social networking application allows the users to listen to the plurality of short audio comments related to the plurality of news events from a plurality of other registered users,
wherein the social networking application allows the users to respond to the short audio comments from the other registered users.

5. The system of claim 1, wherein the server manages the contents presented through the social networking application running on the electronic communication device,
wherein the server automatically updates the news events presented through the GUI of the social networking application after the preset period of time.

6. The system of claim 1, wherein the electronic communication device includes a Smartphone, tablet, computer and other portable and wearable smart electronic devices capable of presenting the contents and receiving the short audio comments on the contents through the GUI of the social networking application.

7. A method of utilizing a social networking application to provide a plurality of contents to a plurality of users and to receive a plurality of comments from the users in response to the plurality of contents, the method includes the steps of:
launching the social networking application from an electronic communication device;
registering into the social networking application by providing a plurality of information through a graphical user interface (GUI) of the social networking application;
viewing the plurality of contents presented through the GUI of the social networking application,
wherein the plurality of contents include a plurality of news events, the news events being presented to the users through the GUI of the social networking application for a preset period of time;
allowing the users to respond to the plurality of news events using at least one short audio comment;
listening to the plurality of short audio comments from a plurality of other registered users; and
exchanging at least one opinion on the plurality of news events in form of the short audio comments;
whereby the social networking application allows the plurality of users to view the plurality of news events, react to the news events through the short audio comments and exchange the plurality of opinions on the news events with the plurality of other registered users in form of the short audio comments.

8. The method of claim 7, wherein the plurality of information submitted through the social networking application during registration includes a plurality of personal information, contents preference information and at least one user profile image of the user,
wherein the social networking application converts the user profile image of the user into a desired avatar image including a cartoon image to protect anonymity of the user.

9. The method of claim 1, wherein the social networking application allows the user to upload at least one image including a logo,
wherein the logo being displayed through the GUI to enable the plurality of other registered users to visualize the logo while listening to the short audio comment from the user.

10. The method of claim 7, wherein the plurality of news events presented through the GUI of the social networking application is periodically updated by a server after the preset period of time.

11. The method of claim 7, wherein the plurality of news events presented through the social networking application includes a plurality of daily updated news events around the world.

12. The method of claim 11, wherein the social networking application allows the users to exchange the opinions on the daily updated news events with the plurality of other registered users in form of the short audio comments and in real-time.
